(19) United States
(12) Patent Application Publication
(10) Pub. No.: US 2019/0265822 A1
(43) Pub. Date: Aug. 29, 2019

(54) TOUCH PANEL WITH AUXILIARY WIRES

(71) Applicants: Jhih-Ciang Bai, Taoyuan (TW); Meng-Guei Lin, Taoyuan (TW); Cing-Fong Lin, Taoyuan (TW); Ciou-Wun Chen, Taoyuan (TW)

(72) Inventors: Jhih-Ciang Bai, Taoyuan (TW); Meng-Guei Lin, Taoyuan (TW); Cing-Fong Lin, Taoyuan (TW); Ciou-Wun Chen, Taoyuan (TW)

(73) Assignee: Young Fast Optoelectronics Co., Ltd., Taoyuan (TW)

(21) Appl. No.: 15/904,401

(22) Filed: Feb. 25, 2018

(51) Int. Cl. G06F 3/041; G06F 3/047

(52) U.S. Cl. CPC G06F 3/0412; G06F 3/047

(57) ABSTRACT

The touch panel includes a transparent substrate, a transparent touch sensor and auxiliary wires. The transparent substrate has a visible area and a shaded area which is around the visible area and formed by an opaque bezel. The transparent touch sensor has touch sensing units arranged into a plurality of sensor columns and located within the visible area. Each of the sensing columns includes a first sensing electrode and a plurality of second sensing electrodes. Each of the first sensing electrodes and the second sensing electrodes is separately connected to a contact disposed in the shaded area through a signal path. Each auxiliary wire is electrically attached to one of the signal paths. An impedance of each auxiliary wire is less than that of each signal path.

### BACKGROUND OF THE INVENTION

### 1. Technical Field

The invention relates to touch panels, particularly to touch panels with improved impedance of touch signal transmission.

### 2. Related Art

A touch panel disposed upon a display for serving as an input device must possess great transmittance to avoid reducing visibility of the image shown on the display. A touch panel includes a transparent substrate and a transparent touch sensor disposed on the substrate. The touch sensor has a plurality of touch sensing electrodes disposed on a visible area of a touch panel. Each of the touch sensing electrodes is electrically connected a contact or silver wire in a shaded area through a signal path. As a result, signals from the touch sensing electrodes can be transmitted to a control unit through the signal paths.

Most of currently available touch sensors are made by indium tin oxide (ITO) film. The above mentioned touch sensing electrodes and signal paths are also formed by the same ITO film. However, with the trend of compactness of electronic products, the touch sensing electrodes and signal paths on the touch sensor become smaller and smaller in size. Particularly, a width of a single signal path is configured into be less than 100 μm. Such a tiny ITO signal path possesses a relatively high impedance, which will attenuate signals transmitted and shorten available length of the signal path. This is very adverse to large-sized touch panels. A signal path with relatively low impedance is a desideratum.

### SUMMARY OF THE INVENTION

An object of the invention is to provide a touch panel with auxiliary wires, which can reduce an impedance of signal transmission paths without decreasing visibility to improve transmission efficiency of touch signals.

To accomplish the above object, the touch panel of the invention includes a transparent substrate, a transparent touch sensor and auxiliary wires. The transparent substrate has a visible area and a shaded area which is around the visible area and formed by an opaque bezel. The transparent touch sensor has touch sensing units arranged into a plurality of sensor columns and located within the visible area. Each of the sensing columns includes a first sensing electrode and a plurality of second sensing electrodes. Each of the first sensing electrodes and the second sensing electrodes is separately connected to a contact disposed in the shaded area through a signal path. Each auxiliary wire is electrically attached to one of the signal paths. An impedance of each auxiliary wire is less than that of each signal path.

### BRIEF DESCRIPTION OF THE DRAWINGS

FIG. 1 is a schematic view of superposition of layers of the first embodiment of the invention;

FIG. 2 is a schematic of layout of the sensing columns of the first embodiment of the invention;

FIG. 3A is an enlarged schematic view of the sensing columns of the first embodiment of the invention, which shows tiny metal wires connected to the signal paths;

FIG. 3B is an enlarged schematic view of the sensing electrode of the sensing columns of the first embodiment of the invention;

FIG. 3C is an enlarged schematic view of the driving electrodes of the sensing columns of the first embodiment of the invention;

FIG. 4 is an enlarged schematic view of the sensing columns of the second embodiment of the invention, which shows tiny metal wires connected to the signal paths and branch conductors; and

FIG. 5 is an enlarged schematic view of the sensing columns of the third embodiment of the invention, which shows tiny metal wires at regular intervals connected to the signal paths and branch conductors.

### DETAILED DESCRIPTION OF THE INVENTION

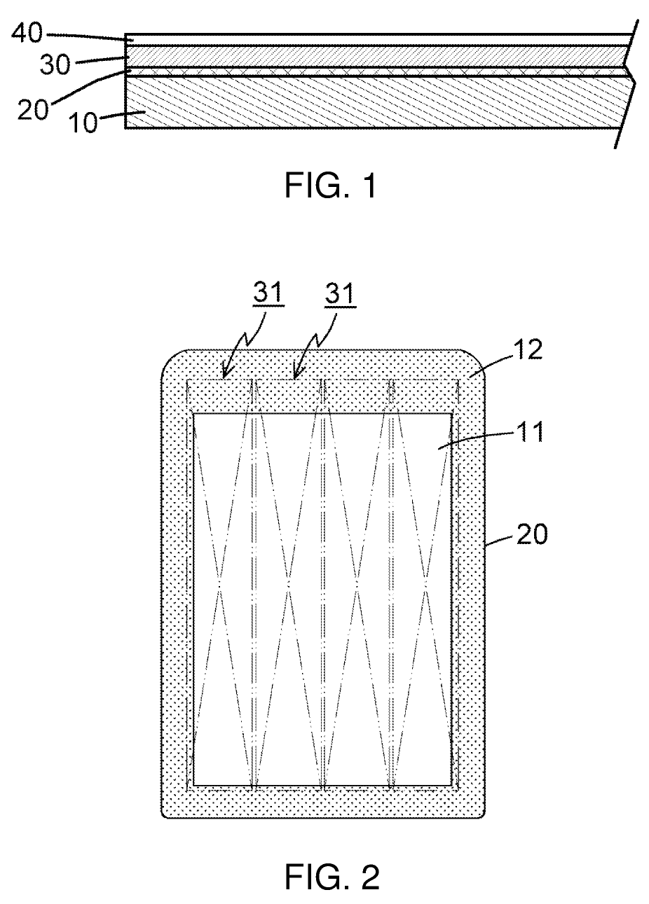

The embodiment shown in FIGS. 1 and 2 is a projected capacitive touch panel composed of a substrate 10, a bezel layer 20, a touch sensing layer 30 and an auxiliary wires layer 40. The substrate 1 may be, but not limited to, a thin plate with high transparency and great mechanical strength such as glass or a transparent flexible film such as polyethylene terephthalate (PET). The bezel layer 20 is arranged on a periphery of the substrate 1 and is formed by an opaque insulative film which may be made of ink or photoresist. The bezel layer 20 defines a hollow shaded area 12 and a visible area within the shaded area 12. The touch sensing layer 30 includes a plurality of sensing columns 31 arranged in the visible area 11.

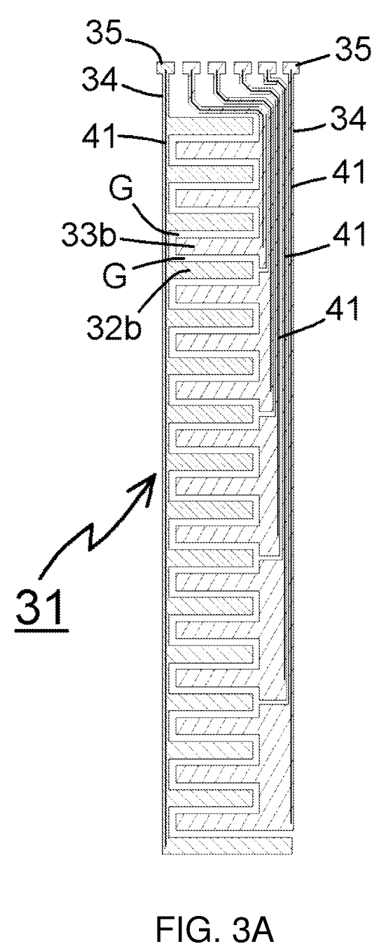

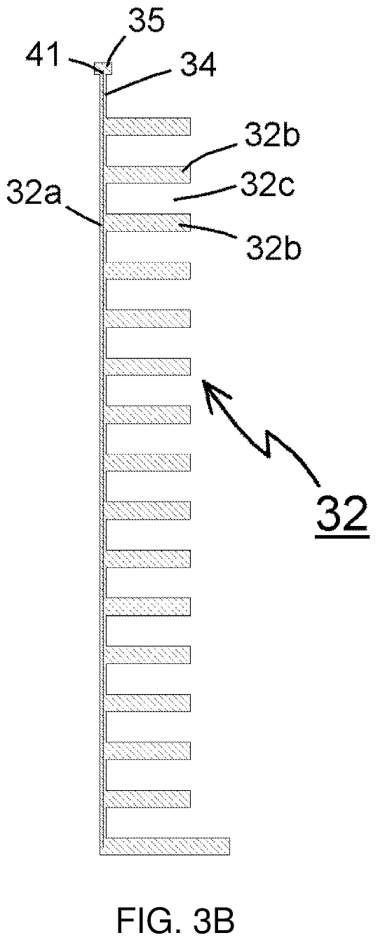

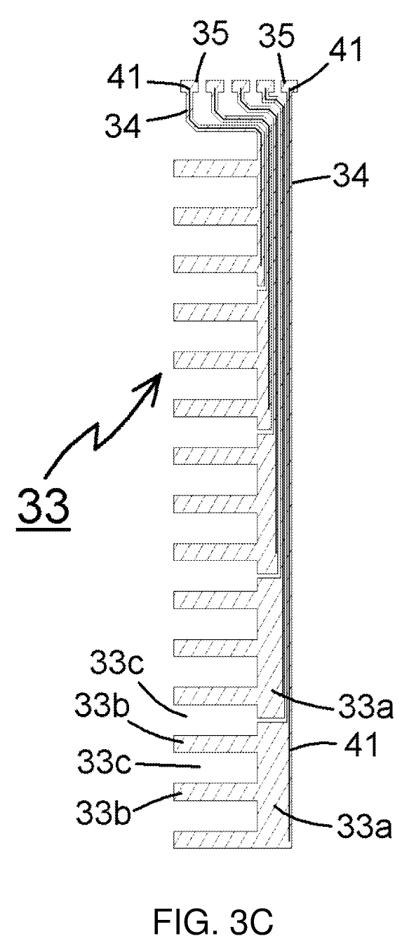

Please refer to FIGS. 3A-3C. Each of the sensing columns 31 is composed of a sensing electrode 32 and a plurality of driving electrodes 33. As shown in FIG. 3B, the sensing electrode 32 is disposed along a Y-axis, and a plurality of branch conductors 32b parallelly extend from a main conductor 32a of the sensing electrode 32 at regular intervals along an X-axis. An insulative space 32c is defined within the main conductor 32a and each two adjacent branch conductors 32b. As shown in FIG. 3C, the driving electrodes 32 are disposed along a Y-axis in a line and with being parallel to the sensing electrode 32, and a plurality of branch conductors 33b parallelly extend from each of main conductors 33a in a line of the driving electrodes 32 at regular intervals along an X-axis. An insulative space 33c is defined within the main conductors 33a and each two adjacent branch conductors 33b.

Please refer to FIG. 3A. The sensing electrode 32 and the driving electrodes 33 are arranged to interlace each other in a complementary pattern, so that each of the branch conductors 32b of the sensing electrode 32 is located in one of the insulative spaces 33c of the driving electrodes 33. Identically, each of the branch conductors 33b of the driving electrodes 33 is located in one of the insulative spaces 32c of the sensing electrode 32. That is, the branch conductors 32b of the sensing electrode 32 are interlaced with the branch conductors 33b of the driving electrodes 33.

The branch conductors 32b, 32c are separately located in the insulative spaces 33c, 32c and a gap G with a width of about 20 μm˜80 μm is formed between edges of the branch conductors 32b, 33b and edges of the insulative spaces 33c, 32c to keep insulation. Each of the main conductors 32a, 33a forms a signal path 34. The main conductors 32a, 33a of the sensing electrode 32 and driving electrodes 33 are used for transmitting signals from the branch conductors 32b, 33b, so each main conductor 32a, 33a is electrically connected to one of contacts 35 disposed in the shaded area 11 through one of the signal paths 34. The touch sensing layer 30 is a transparent conductive film, such as an indium tin oxide, indium zinc oxide, aluminum zinc oxide or polyethylenedioxythiophene thin film.

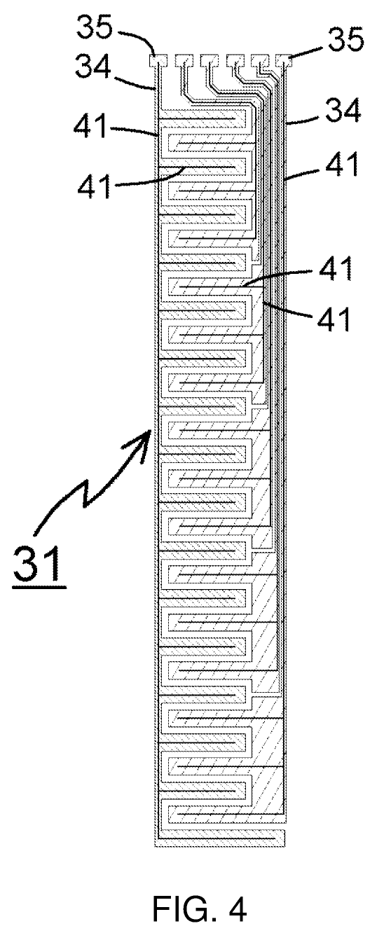

The auxiliary wires layer 40 is superposed on the touch sensing layer 30 and has tiny metal wires 41. Each metal wires 41 is electrically attached to one of the signal paths 34 so that an end of each metal wire 41 is electrically connected to one of the contacts 35 and the other end thereof is electrically attached to one of the main conductors 32a, 33a as shown in FIGS. 3A-3C or is extended to be electrically attached on one of the branch conductors 32b, 33b as shown in FIG. 4. The metal wires are made of gold, silver, copper, aluminum, molybdenum or their alloys. The material of the metal wires 41 is less than that of the signal paths 34 (ITO) in impedance, so the metal wires 41 can help signal transmission, reduce an impedance between the main conductors 32a, 33a and the contacts 35 and decrease signal attenuation in transmission. A diameter of each auxiliary wire 41 is configured to be less than 25 μm, preferably less than 5 μm, so these metal wires 41 do not affect visibility of the display by naked eyes even if they are not transparent.

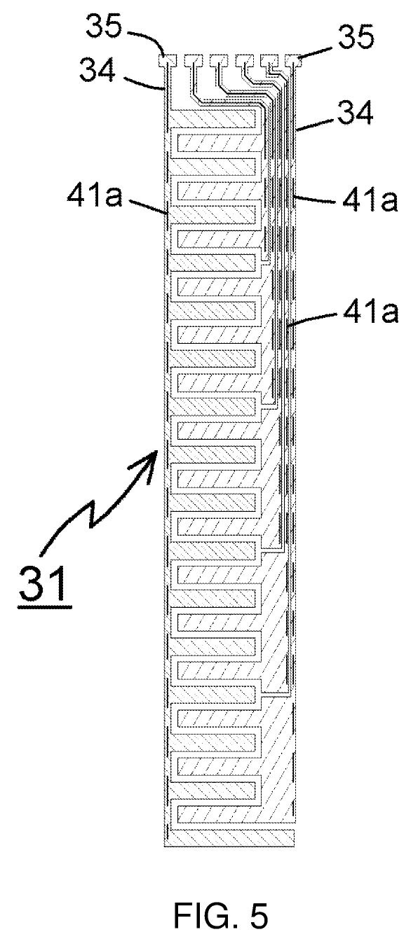

The metal wires 41 may be straight, waved or irregular lines. The auxiliary wire may be composed of discontinuous wires 41a as shown in FIG. 5.

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

1. A touch panel comprising:
a transparent substrate;
a bezel layer, superposed on a periphery of the transparent substrate and formed by an opaque insulative film to define a shaded area and a visible area encompassed in the shaded area on the transparent substrate;
a touch sensing layer, superposed on the bezel layer, having a transparent touch sensor, the transparent touch sensor having touch sensing units arranged into a plurality of sensor columns and located within the visible area, each of the sensing columns comprising a first sensing electrode and a plurality of second sensing electrodes, each of the first sensing electrodes and the second sensing electrodes being separately connected to one of contacts disposed in the shaded area through a signal path located within the visible area; and
an auxiliary wires layer, superposed on the touch sensing layer, having auxiliary wires located within the visible area, each auxiliary wire being electrically attached on one of the signal paths;
wherein an impedance of each auxiliary wire is less than that of each signal path, and a diameter of each auxiliary wire is less than 25 μm.

2. The touch panel of claim 1, wherein the touch sensing layer is a transparent conductive film made of indium tin oxide, indium zinc oxide, aluminum zinc oxide or polyethylenedioxythiophene.

3. The touch panel of claim 1, wherein the auxiliary wires are made of gold, silver, copper, aluminum, molybdenum or an alloy thereof.

4. The touch panel of claim 1, wherein the diameter of each auxiliary wire is less than 5 μm.

5. The touch panel of claim 1, wherein the auxiliary wires are straight lines.

6. The touch panel of claim 1, wherein each of the auxiliary wires is composed of discontinuous wires.

7. The touch panel of claim 1, wherein:
the first sensing electrode has a first main conductor forming the signal path along a first direction and a plurality of first branch conductors parallelly extend from the first main conductor at regular intervals along a second direction, a first insulative space is defined within the first main conductor and each two adjacent first branch conductors;
each second sensing electrode has a second main conductor forming the signal path along the first direction and a plurality of second branch conductors parallelly extend from the second main conductor at regular intervals along the second direction, a second insulative space is defined within the second main conductor and each two adjacent second branch conductors; and
each of the second branch conductors is located in one of the first insulative spaces, each of the first branch conductors is located in one of the second insulative spaces.

8. The touch panel of claim 7, wherein an end of each auxiliary wire is electrically connected to one of the contacts and another end thereof is electrically attached to one of the main conductors.

9. The touch panel of claim 7, wherein an end of each auxiliary wire is electrically connected to one of the contacts and another end thereof is extended to be electrically attached on one of the branch conductors.
